(19) United States
(12) Patent Application Publication
(10) Pub. No.: US 2005/0072198 A1
(43) Pub. Date: Apr. 7, 2005

(54) Key cover for a shared key

(76) Inventors: Elena Casellini, Adligenswil (CH); Julia Schwobel, Luzern (CH)

Correspondence Address: GIFFORD, KRASS, GROH, SPRINKLE & CITKOWSKI, P.C, PO BOX 7021, TROY, MI, 48007-7021, US

(21) Appl. No.: 10/680,747

(22) Filed: Oct. 7, 2003

(51) Int. Cl. E05B 19/04; E05B 19/24

(52) U.S. Cl. 70/408; 70/460

(57) ABSTRACT

A key cover has a first sidewall having an aperture therethrough and a second sidewall that together define a space capable of receiving a conventional key therein. The key having an opening that when the key is inserted into the key holder aligns with the first sidewall aperture and simultaneously aligns with an aperture in the second sidewall. A tactile feature is present on a sidewall or sidewall edge such that the key cover can be identified by feel or described to another individual without producing the key cover or inserted key for their inspection.

### FIELD OF THE INVENTION

The present invention generally relates to a protective cover for a key and in particular, to a key cover that has a tactile distinguishing feature integrated therewith.

### BACKGROUND OF THE INVENTION

In modem society, an individual is responsible for a variety of pass keys affording access to restricted areas such as a residence, a business, a vehicle and a storage facility. The familiarity an individual has regarding a particular key is difficult to convey to another person without actually giving the other person the key, and to use the key in low light conditions remains problematic. The difficulty of key sharing is compounded when the other person processes information differently such as in the relationship between an adult and child, a sighted person and a visually impaired person, and between normally functioning and mentally impaired persons. While a conventional solution to the problem of shared keys is affixing descriptive written labels to each of the keys, such labels are often unintelligible among members of the above-described relationships. Further, such descriptive labels are readily damaged in the course of normal usage and create an additional security risk if the keys are ever lost or stolen. Additionally, such labels are of little value when attempting to find a key under low light conditions. Thus, there exists a need for a key cover that identifies a key through tactile and non-alphanumeric symbolic visual senses.

### SUMMARY OF THE INVENTION

A key cover includes a pair of sidewalls defining a space therebetween. The space adapted to receive a key having an opening. The first sidewall has an aperture capable of alignment with the opening in the key, and likewise the second sidewall has an aperture capable of simultaneous alignment with the opening in the key and the aperture in the first sidewall. A tactile feature is present in at least one of a sidewall or a sidewall edge. The tactile feature having a discernible feel that is readily described to an individual in the absence of the key cover and is also distinguishable by touch from other keys or key covers present in a grouping.

A key cover is readily formed by casting molten metal or injection molding a thermoplastic into a mold having a void complementary to a key cover. After the metal has solidified, the resulting casting is polished.

### BRIEF DESCRIPTION OF THE DRAWING

The present is further described with reference to the following figures. These figures are not intended to be a limitation upon the scope and practice of the present invention.

FIG. 1 is a perspective view of an inventive key cover embodiment;

FIG. 2 is a side view of the embodiment depicted in FIG. 1;

FIG. 3 is a cutaway view of the embodiment depicted in FIG. 1 along axis A-A′; and

FIG. 4 is a perspective view of an inventive key ring, showing several inventive key cover designs.

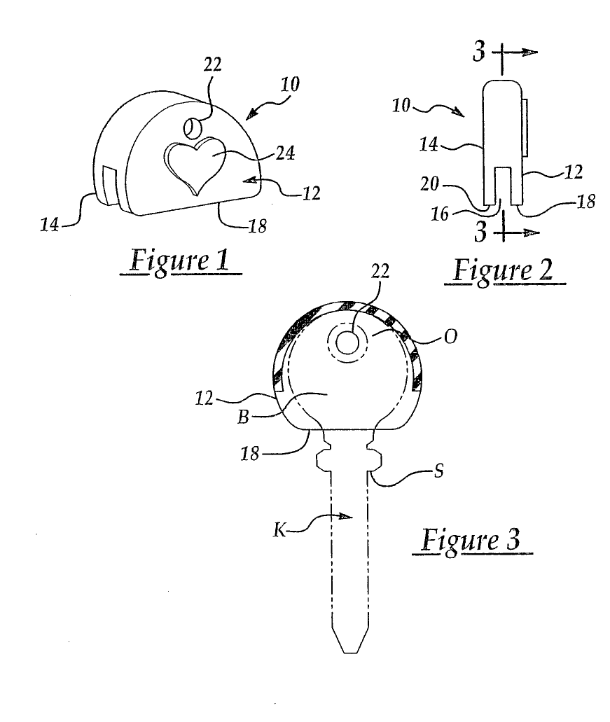

### DETAILED DESCRIPTION OF THE PREFERRED EMBODIMENTS

The present invention has utility as a key cover to protect the key bow from undue wear and further to facilitate shared key usage between several individuals and usage under low light conditions. An inventive key cover is characterized by a slot adapted to receive a conventional key therein. The key cover has formed on a sidewall thereof a topological feature that provides tactile and visual information that is readily conveyed between individuals without resort to conventional key identifiers. Additionally, a sighted key user can readily identify a particular key by feel from among a variety of keys under poor light conditions or a visually impaired key user can identify by feel a particular key and, unlike Braille, communicate the feel of the key to a sighted individual.

Referring now to the figures, an inventive key cover is shown generally at 10. The key cover 10 has a first sidewall 12 spaced a predetermined distance from a second sidewall 14, each of the first sidewall 12 and second sidewall 14 terminating in edges 18 and 20, respectively. Intermediate between the first sidewall 12 and the second sidewall 14 is a space 16 adapted to receive the bow of a key (shown in ghost at K). The inventive key cover 10 while encompassing a portion of the ey bow, the edges 18 and 20 do not extend so as to overlap the key shoulder. The first sidewall 12 has an aperture 22 therethrough in alignment with an opening in the key bow. Likewise, second sidewall 14 has an aperture therethrough (not shown) in alignment with aperture 22.

An inventive key cover form incorporates a tactile feature on first sidewall 12 or along first sidewall edge 16. As used herein “tactile feature” is defined to include a raised or depressed topological aspect relative to a plane defined by the sidewall or lower edge of an inventive key cover form. Tactile features according to the present invention illustratively include raised or depressed geometric shapes integral with a sidewall and illustratively including a circle, a triangle, a square, a parallelogram, a bar, a star, a cross, a heart, and an icon of such features as a house, a vehicle, an animal, and a human form; and an edge treatment illustratively including a row of three-dimensional shapes such as spheres, pyramids, cubes, or combinations thereof; a barbell; and a braid. While it is appreciated that any number of tactile features are operative within the present invention, such a feature must have a discernable feel that is readily described orally in the absence of the inventive key cover. Optionally, the tactile feature 22 is duplicated on the second sidewall 14 or second edge 18.

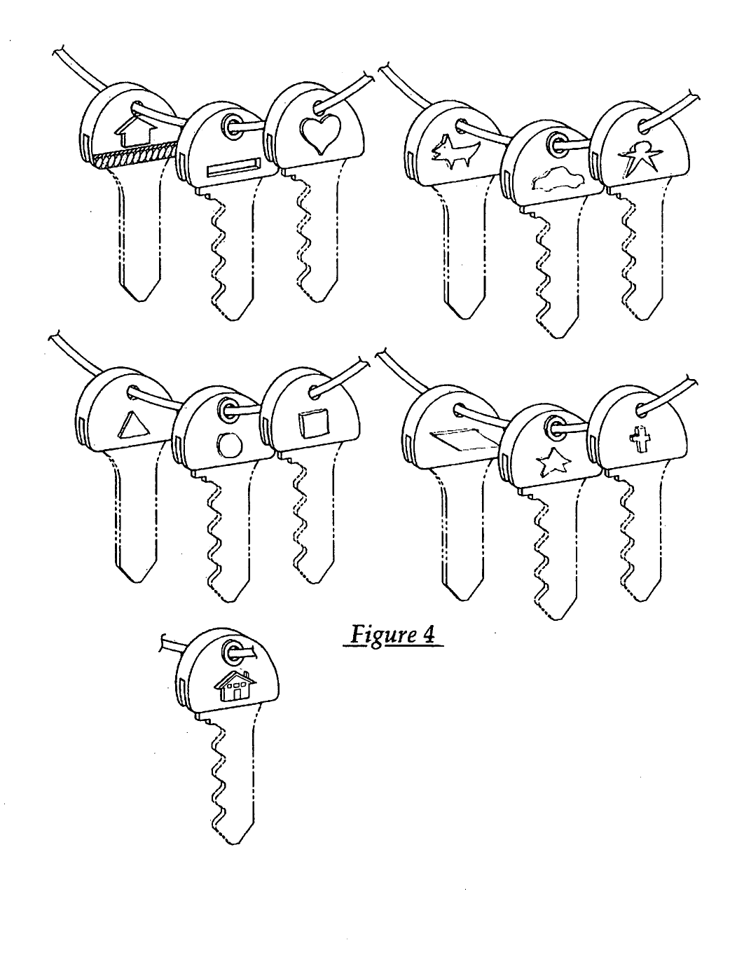

With particular reference to FIG. 4, a key ring including at least two keys encompassed by inventive key covers is operative to operate locks under poor lighting conditions where each of the key covers has a different tactile feature associated therewith. A user through touch is able to identify each of the key covers and thereby select the appropriate key for a given lock. Additionally, a user can readily communicate to another individual corresponds to a particular key.

An inventive key cover is composed of a variety of metals illustratively including pure or alloyed forms of aluminum, iron, brass, zinc, tin and silver; and injection moldable thermoplastics illustratively including olefins; polyurethanes; polyesters; polyolefins such as polyethylene; aliphatic polyamide; polycarbonate; polyacrylonitrile; polycarbonate; polyvinyl chloride; and polystyrene. It is appreciated that an inventive key cover can readily include ornamental decorations or indicia formed from media illustratively including paint, resin, enamel and various inlays. Such ornamentation serves not only an aesthetic function, but also modifies the thermal conductivity and texture of the inventive key cover so as to further enhance tactile differences between individual embodiments of inventive key covers. Preferably, an inventive key cover is produced by casting or by injection molding. Preferably, the key cover is casted of 925 silver. The tactile feature being integrated into the casting mold. Subsequent to casting, an inventive key cover is deburred and polished in a polishing drum or with a sand stream machine to a desired surface finish. Paint, resin, enamel and inlays are integrated into an inventive key cover by methods conventional to the jewelry arts.

The foregoing description is illustrative of particular embodiments of the invention, but is not meant to be a limitation upon the practice thereof. The following claims, including all equivalents thereof, are intended to define the scope of the invention.

1. A key cover for covering a head of a key, where the head has an opening for receiving a key ring therethrough, said key cover comprising:
a first sidewall defining a plane and terminating in a first edge, the first sidewall having a first aperture therethrough;
a second sidewall terminating in a second edge, the second sidewall having a second aperture therethrough;
an outer wall extending between the first and second sidewalls to define a recess that receives the head of the key therein so that the opening in the head is aligned with the first aperture and the second aperture, the outer wall having ends that are spaced apart from the first and second edges of the first and second sidewalls, respectively; and
a tactile feature integrally formed on the plane of the first sidewall.

2. The key cover of claim 1 wherein the tactile feature is a geometric shape on the first sidewall.

3. The key cover of claim 2 wherein the geometric shape is selected from the group consisting of: a circle, a triangle, a square, a parallelogram, a star, a cross, a house icon, an animal icon, a vehicle icon, and a human icon.

4. The key cover of claim 2 wherein geometric shape is raised above the plane of the first sidewall.

5. The key cover of claim 2 wherein the geometric shape is depressed relative to the plane of the first sidewall.

6. The key cover of claim 1 wherein the tactile feature is a raised treatment along the first edge protruding outwardly from plane of the first sidewall.

7. The key cover of claim 6 wherein the edge treatment is selected from the group consisting of: a repeating row of three-dimensional geometric shapes, a barbell, and a braid.

8. The key cover of claim 1 further comprising a second tactile feature integral with a portion of said key cover selected from the group consisting of: the second sidewall and the second edge.

9. The key cover of claim 8 wherein the tactile feature and the second tactile feature are identical and in opposition.

10. (Canceled)

11. A key ring comprising:
a first key having a first opening therethrough, said first key encompassed by a key cover according to claim 1;
a second key having a second opening therethrough, said second key encompassed by a second key cover according to claim 1 wherein the second key cover has a different tactile feature relative to said first key cover; and
a securement simultaneously engaging the first key opening, the first key cover, the second key opening and the second key cover.

12. A key cover of claim 1 obtainable by a process comprising the steps of:
casting molten metal into a mold having a void complementary to said key cover of claim 1;
allowing said molten metal sufficient time to solidify into a key cover casting; and
polishing said casting.

13. A key cover of claim 12 wherein the molten metal is selected from the group consisting of a pure or alloyed form of: aluminum, iron, brass, silver, tin, and zinc.

14. The key cover of claim 12 produced by a process further comprising the step of: having a textural surface treatment to said key cover.

15. The key cover of claim 14 wherein the textural treatment is selected from the group consisting of: paint, resin, enamel and an inlay.

16. A key cover of claim 1 obtainable by a process comprising the steps of:
injection molding thermoplastic into a mold having a void complimentary to said key cover of claim 1;
allowing said thermoplastic sufficient time to solidify into a key cover casting; and
polishing said casting.

17. A key cover of claim 16 wherein the thermoplastic is selected from the group consisting of olefins; polyurethanes; polyesters; polyolefins; aliphatic polyamide; polycarbonate; polyacrylonitrile; polycarbonate; polyvinyl chloride; and polystyrene.

18. The key cover of claim 16 produced by a process further comprising the step of: having a textural surface treatment to said key cover.

19. The key cover of claim 18 wherein the textural treatment is selected from the group consisting of: paint, resin, enamel and an inlay.

20. A key cover comprising:
a first sidewall defining a plane and terminating in a first edge, the first sidewall having a first aperture therethrough;
a second sidewall terminating in a second edge, the second sidewall having a second aperture therethrough such that the key cover is adapted to receive a key having an opening between the first sidewall and the second sidewall and the opening of the key is in alignment with the first aperture and the second aperture; and
a first tactile feature integrally formed on the plane of the first sidewall; and
a second tactile feature integrally formed both on the plane and along the first edge of the first sidewall.

21. The key cover of claim 21 wherein the first tactile feature is a geometric shape on the first sidewall.

22. The key cover of claim 22 wherein the geometric shape is selected from the group consisting of: a circle, a triangle, a square, a parallelogram, a star, a cross, a house icon, an animal icon, a vehicle icon, and a human icon.

23. The key cover of claim 21 wherein the second tactile feature is a raised treatment along the first edge.

24. A key cover for covering a head of a key, where the head has an opening for receiving a key ring therethrough, said key cover comprising:
a first sidewall defining a plane and terminating in a first edge, the first sidewall having a first aperture therethrough;
a second sidewall terminating in a second edge, the second sidewall having a second aperture therethrough, the second sidewall being spaced apart from said first sidewall to define a recess that receives the head of the key therein so that the opening in the head is aligned with the first aperture and the second aperture; and
a tactile feature formed on the plane of the first sidewall, the tactile feature being selected from the group consisting of: paint, resin, enamel and an inlay.
